(19) United States
(12) Patent Application Publication
(10) Pub. No.: US 2002/0147037 A1
(43) Pub. Date: Oct. 10, 2002

(54) Power supply apparatus and method of supplying power to a mobile communication terminal

(75) Inventor: Seong Tae Kwon, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/117,129

(22) Filed: Apr. 8, 2002

(30) Foreign Application Priority Data
Apr. 6, 2001 (KR) 18285/2001

(51) Int. Cl. H04M 1/00

(52) U.S. Cl. 455/574; 455/572; 455/556

(57) ABSTRACT

A power supply apparatus and method of supplying power to a mobile communication terminal are disclosed. When a battery's power for a communication module is used up, power from a battery for a personal digital assistant (PDA) module is supplied to the communication module to allow further use of the communication module. When the remaining capacity of the battery for the PDA module goes to a level of at which the PDA module is not operable, the power supply to the PDA module can be discontinued and power can be supplied to the communication module. Thus, call service can be continuously provided, even at lower battery power levels, to a user of the mobile communication terminal.

### BACKGROUND OF THE INVENTION

1. Field of the Invention

The present invention relates to a mobile communication terminal, and more particularly, to a power supply apparatus and method of supplying power to a mobile communication terminal.

2. Background of the Related Art

In general, a mobile communication terminal (referred to as ‘terminal’, hereinafter) includes a PDA (personal digital assistant) module for transmission or reception of e-mails or internet Web surfing and a communication module for voice communication. The PDA module and the communication module usually receive power through a common battery or a dual battery. The common battery supplies power to both the PDA and the communication module, while the dual battery supplies power to the PDA module and the communication module individually by using separate batteries.

In the related art, when a common battery is used, the common battery use time is shortened due to the high power consumptions by the display unit, the short message services (SMS) or the call services of the terminal. When a dual battery is used and the battery power for the communication module is used up, the use time of the entire terminal is shortened and there is no way to extend the use time for the call service.

The above references are incorporated by reference herein where appropriate for appropriate teachings of additional or alternative details, features and/or technical background.

### SUMMARY OF THE INVENTION

An object of the invention is to provide a power supply apparatus and method of supplying power to a mobile communication terminal that is capable of extending a call service use time of a terminal having a common battery.

Another object of the present invention is to provide a power supply apparatus and method of a mobile communication terminal that is capable of extending a call service use time of a terminal having a dual battery.

To achieve at least the above objects in whole or in parts, there is provided a power supply apparatus of a mobile communication terminal including: a common battery for supplying a power to a PDA module and a communication module, a relay switch connected between the common battery and the PDA module, and a level sensing unit for turning off the relay switch if a remaining capacity of the common battery is below a predetermined level.

To achieve at least these advantages in whole or in parts, there is further provided a power supply apparatus of a mobile communication terminal including: a first battery for supplying a power to a PDA module, a second battery for supplying a power to a communication module, a first relay switch connected between the first battery and the PDA module, a second relay switch connected between the first battery and the communication module, a first level sensing means for sensing the remaining capacity of the first battery and controlling the first relay switch, and a second level sensing means for sensing the remaining capacity of the second battery and controlling the second relay switch.

To achieve at least these advantages in whole or in parts, there is further provided a power supply apparatus of a mobile communication terminal including: a first battery for supplying a power to a PDA module, a second battery for supplying a power to a communication module, a first relay switch connected between the first battery and the PDA module, a second relay switch connected between the first battery and the communications module, first and second level sensing units for sensing a remaining capacity of first and second batteries, and a controller for controlling operations of the first and second relay switches and the PDA module according to a remaining capacity of the first and second batteries.

To achieve at least these advantages in whole or in parts, there is further provided a power supply method of a mobile communication terminal including supplying a power from a common battery to a PDA module and a communication module, sensing a remaining capacity of the common battery, and cutting off the power from the common battery to the PDA module if the sensed remaining capacity is below a predetermined level.

To achieve at least these advantages in whole or in parts, there is further provided a power supply method of a mobile communication terminal including supplying power from a first battery to a PDA module, supplying power from a second battery to a communication module, detecting a remaining capacity of the first and second batteries, and controlling power from the first battery to the communication module and from the first battery to the PDA module.

Also provided is a preferable method of controlling the power supply of a mobile communication terminal in accordance with the present invention which includes checking whether the remaining capacity of the second battery is below a second level, supplying a power from the first battery to the communication module if the remaining capacity of the second battery is below the second level, checking whether the remaining capacity of the first battery is below a first level, and cutting off a power supply from the first battery to the PDA module if the remaining capacity of the first battery is below a first level.

Additionally, another preferable method of controlling the power supply of a mobile communication terminal in accordance with the present invention includes checking whether the remaining capacity of the second battery is below a second level, checking whether the remaining capacity of the first battery is above the first level if the remaining capacity of the second battery is below the second level, supplying a power of the first battery to the communication module if the remaining capacity of the first battery is above the first level, and cutting off power from the first battery to the PDA module if the remaining capacity of the first battery is below the first level.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic block diagram of a power supply apparatus of a mobile communication terminal having a common battery in accordance with a first embodiment of the present invention;

FIG. 2 is a flow chart of a power supply operation of FIG. 1 in accordance with the first embodiment of the present invention;

FIG. 3 is a schematic block diagram of a power supply apparatus of a mobile communication terminal having a dual battery in accordance with a second embodiment of the present invention;

FIG. 4 is a flow chart of a power supply operation of FIG. 3 in accordance with the second embodiment of the present invention;

FIG. 5 is a schematic block diagram of a power supply apparatus of a mobile communication terminal having a dual battery in accordance with a third embodiment of the present invention; and

FIG. 6 is a flow chart of a power supply operation of FIG. 5 in accordance with the third embodiment of the present invention.

### DETAILED DESCRIPTION OF PREFERRED EMBODIMENTS

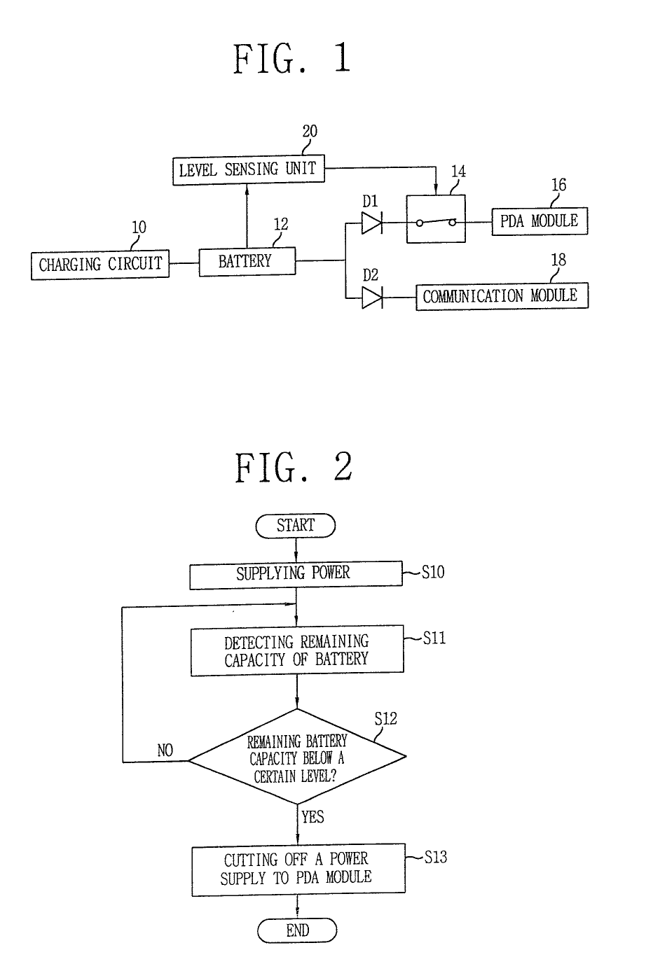

The operation of the power supply apparatus of a mobile communication terminal in accordance with the first embodiment of the present invention constructed as described above will now be explained with reference to FIGS. 1 and 2.

FIG. 1 is a schematic block diagram of a power supply apparatus of a mobile communication terminal having a common battery in accordance with a first embodiment of the present invention. As shown in FIG. 1, a power supply apparatus of a mobile communication terminal includes a battery 12 charged by a charging circuit 10 and commonly supplying power to both a PDA module 16 and a communication module 18. Also illustrated in FIG. 1 is a relay switch 14 connected between the battery 12 and the PDA module 16, and a level sensing unit 20 for sensing a remaining capacity of the battery 12 and controlling the relay switch 14. D1 and D2 are reverse current preventing diodes.

Generally, the battery 12 can be directly charged by the charging circuit 10 or can be charged through a separate charging device and mounted in the terminal. After the battery 12 is charged, when a user depresses a power supply key S10, the first relay switch 14 can be maintained in an ON state at an initial stage. Accordingly, the charging power of the battery 12 can also be supplied to the PDA module 16 through the diode D1 and the relay switch 14, and simultaneously, supplied to the communication module 18 through the diode D2.

At this time, the level sensing unit 20 detects the remaining capacity of the battery 12 and checks whether the detected remaining capacity of the battery is below a predetermined level (steps S11 and S12). Next, if the detected battery capacity is below the predetermined level, the level sensing unit 20 turns off the relay switch 14 to cut off power from the battery to the PDA module 16 (step S13). Accordingly, if the power of the battery 12 is supplied only to the communication module 18, even if the remaining capacity of the battery 12 is short, the user can maximize the power supplied to the communication module 18 and thus extend the power to a call service.

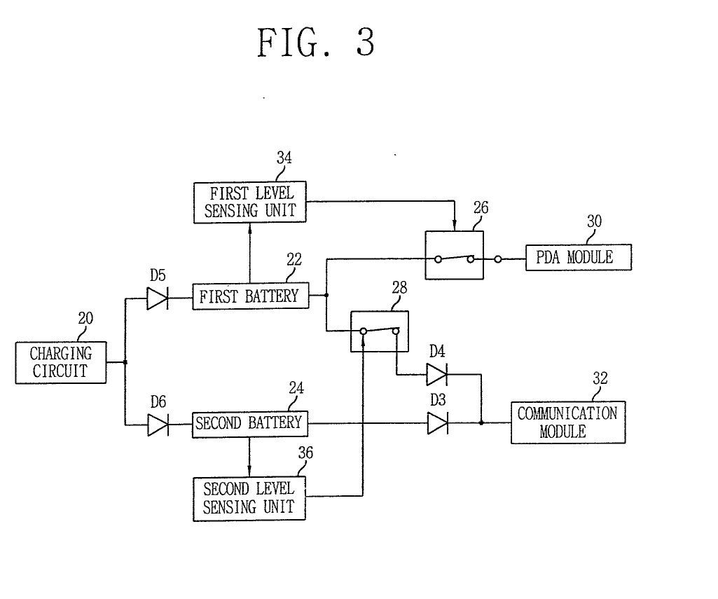

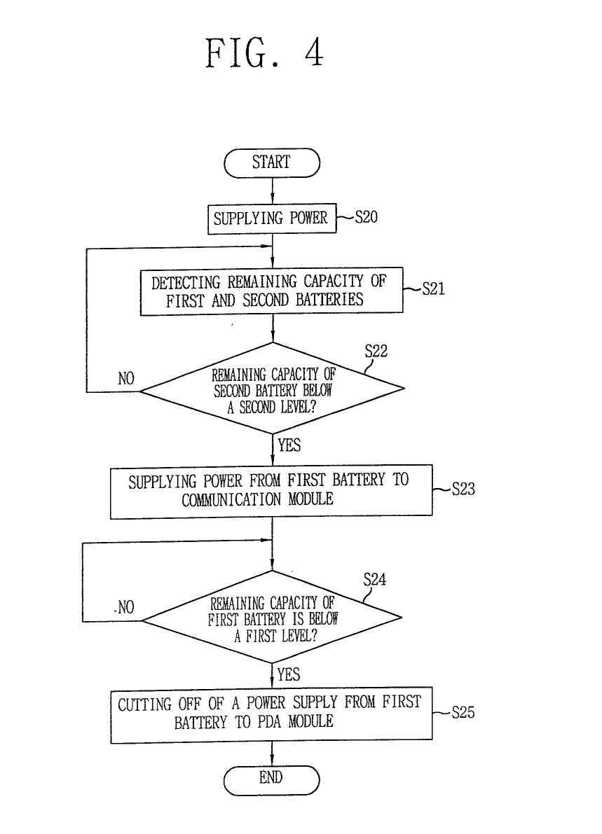

FIG. 3 is a schematic block diagram of a power supply apparatus of a mobile communication terminal having a dual battery in accordance with a second embodiment of the present invention. As shown in FIG. 3, a preferred power supply apparatus of a mobile communication terminal can include first and second batteries 22 and 24 for respectively supplying power to a PDA module 30 and a communication module 32, a first relay switch 26 connected between the first battery 22 and the PDA module 26, and a second relay switch 28 connected between the first battery 22 and the communication module 32.

In addition, the apparatus can also include a first level sensing unit 34 for sensing i a remaining capacity of the first battery 22 and controlling the first relay switch 26 and a second level sensing unit 36 for sensing a remaining capacity of the second battery 24 and controlling the second relay switch 28. The first and second batteries 22 and 24 are usually batteries for a PDA module 30 and a communication module 32, respectively, and D3-D6 are preferably reverse current preventing diodes.

The operation of the power supply apparatus of a mobile communication terminal in accordance with the second embodiment of the present invention would begin with the charging of the first and second batteries, 22, 24. After the first battery 22 is charged by the charging circuit 20, the charging is discontinued, and if the power in the first and second batteries is adequate, the first relay switch 26 can be turned on and the second relay switch 28 can be turned off so that the first battery can supply power to the PDA alone through the first switch 26 and the power of the second battery 24 can be supplied to the communication module 32 alone through the diode D3 (step S20).

Next, the first and second level sensing units 34 and 36, respectively, detect a remaining capacity of the first and second batteries 22 and 24 and determine how to control the first and second relay switches 26 and 28 depending on the remaining capacities of the batteries 24, 26 as detected. That is, the second level sensing unit 36 detects a remaining capacity of the second battery 24 and checks whether the detected remaining battery capacity is below a second level (steps S21 and S22). If the remaining capacity of the second battery 24 is above the second level, the second level sensing unit 36 keeps on performing the detecting operation. If, however, the remaining capacity of the second battery 24 is below the second level, the second level sensing unit 36 turns on the second relay switch 28 so that the power of the first battery 22 can be supplied to the communication module 32 through the diode D4 (step S25). At this time, the second level can be a power level at which the communication module 32 may not be stably operable.

Accordingly, as the communication module 32 receives power from the first battery 22, it can provide calling service to the user, and since the PDA module 30 also can continuously receive power from the first battery 22, the user can smoothly perform transmission and reception of e-mail and Web surfing using both the PDA and communication modules 30, 32. In this state, the first level sensing unit 34 continuously checks whether the remaining capacity of the first battery 22 is below the first level. If the remaining capacity of the first battery 22 is below the first level, the first level sensing unit 34 turns off the first relay switch 26 to cut off power from the first battery 22 to the PDA module 30, so that the power of the first battery 22 is supplied only to the communication module 32. The first level can be set as a power level at which the PDA module 30 may not be stably operable, or set as a power level at which the PDA module 30 is operable and the communication module 32 is stably operable for an arbitrary time. Preferably, the first level is higher than the second level.

In summary, if the battery power for the communication module 32 is used up (i.e., the second battery 24), the power of the battery for the PDA module 30 (i.e., the first battery 22) can be shared with the communication module 32. On the other hand, if the battery for the PDA module 30 is used up, the PDA module 30 can be turned off and power can be solely supplied to the communication module 32 to extend a user's available time of the call service.

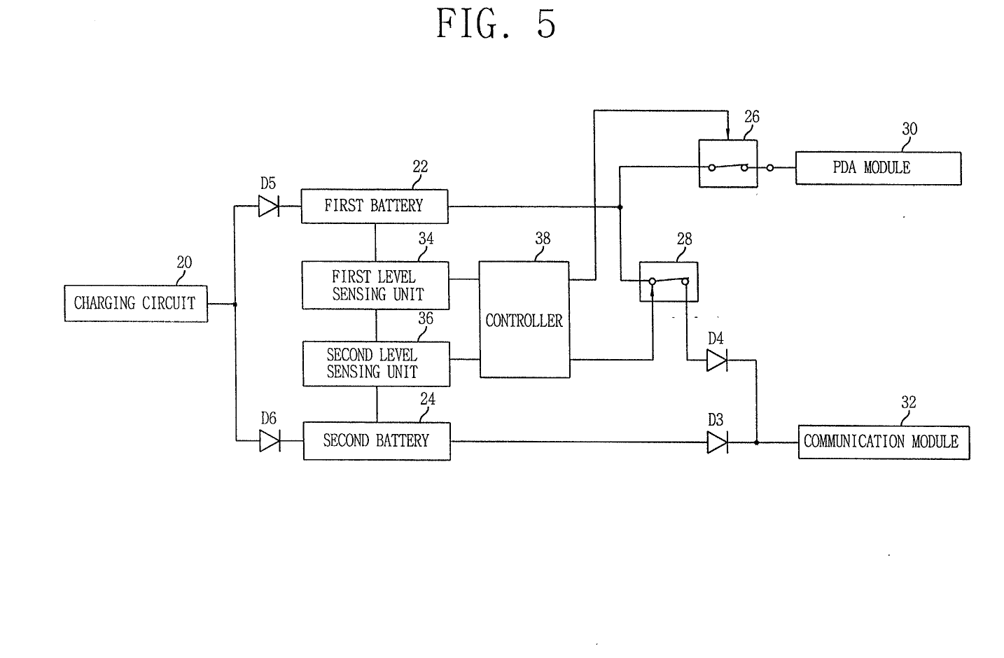

FIG. 5 is a schematic block diagram of a power supply apparatus of a mobile communication terminal having a dual battery in accordance with a third embodiment of the present invention. As shown in FIG. 5, a controller 38 is added to the power supply apparatus of a mobile communication terminal in accordance with the second embodiment of the present invention. The controller 38 can be used to receive a sensing level from the first and second level sensing units 34 and 36 and to control the operations of the first and second relay switches 26 and 28 and the operation of the PDA module 30.

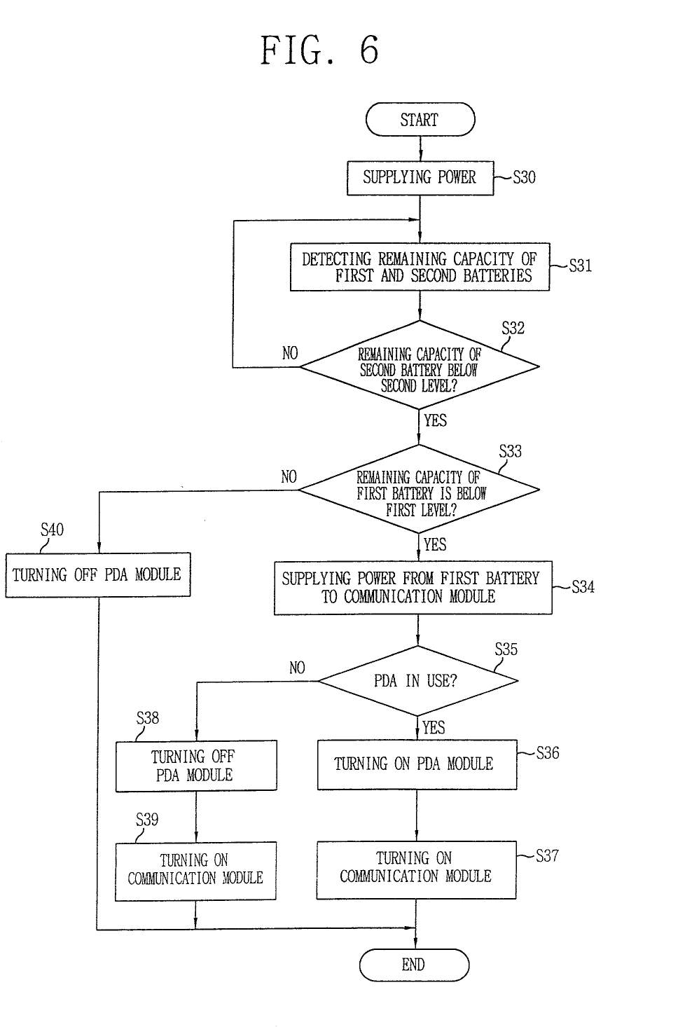

As shown in FIG. 6, when the first and second batteries 22, 24 have been charged by the charging circuit 20, the first and second batteries 22, 24 can be used as the power sources for the terminal. If each battery has an adequate amount of power, the first relay switch 26 is turned on and the second relay switch 28 is turned off. Accordingly, the power of the first battery 22 can be supplied to the PDA module 30 alone through the first switch 26 and the power of the second battery 24 can be supplied to the communication module 32 alone through the diode D3.

At this time, the first and second level sensing units 34 and 36, respectively, detect the remaining capacities of the first and second batteries 22 and 24 and supplies information on the detected capacities to the controller 38. Then, the controller 38 can be used to control the operations of the first and second relay switches 26 and 28 and the PDA module 30 according to the remaining capacity of the first and second batteries 22 and 24. The controller 38 can also be used to determine whether the remaining capacity of the second battery 24, as provided by the second level sensing unit 36, is below a second level (steps S31 and S32). In this respect, the second level is a power level at which the communication module 32 is not stably operable.

If the remaining capacity of the second battery 24 is above the second level, the controller 38 can check whether the remaining capacity of the first battery 22 is above a first level (step S33). If the remaining capacity of the first battery 22 is above the first level, the controller 38 turns on the second relay switch 28 to provide the power of the first battery 22 to the communication module 32. In this respect, the first level can be set as a power level at which the PDA module 30 may not be stably operable, or set as a power level at which the PDA module 30 can be operable and the communication module 32 can be stably operable. Generally, the first level is higher than the second level.

Accordingly, as the communication module 32 can receive power from the first battery 22 after exhausting the second battery 24, it can provide call service to the user, and since the PDA module 30 also continuously receives power from the first battery 22, the user can continue the use of both the communication and PDA modules 32, 30.

In addition to transferring all the power of the first battery 22 to the communication module 32, the controller 38 can also be used to reduce the power consumption of the first battery 22. This can be accomplished by supplying power from the first battery 22 to the PDA module 30 only when necessary, for example, when e-mail or Web surfing service is accessed. For example, when power is initiated from the first battery 22 to the communication module 32, the controller 38 can check whether the PDA is currently being used (step S35). If the PDA is currently used, the controller 38 can then turn on the PDA module 30 and the communication module 32 (steps S36 and S37). If, however, the PDA module is not used, the controller 38 can turn off the PDA module 30 and turn on only the communication module 32, thereby reducing the power consumption of the first battery 22 (steps S38 and S39).

Thereafter, if the remaining capacity of the first battery is below the first level, the controller 38 can turn off the first relay switch 26 to cut off power from the first battery 22 to the PDA module 30, so that the PDA module 30 is turned off. As a matter of course, since the second relay switch 28 is maintained in the ON state, power can be continuously supplied from the first battery 22 to the communication module 32, so that the user can continuously use the call service.

Also, as a further way to minimize power consumption, power to a display of a terminal can be limited in a preferred embodiment by power being limited to only the communication module 32 and only a portion of the whole display. The display unit may also be dividedly constructed into sections as where only specific sections (i.e., relating to the communication module 32) are driven when a power is supplied to either or both of the PDA module 30 and the communication module 32, so that the power consumption by the display can be minimized, for example, power can be supplied to only the communication module sections of the display when call service is accessed.

The power supply apparatus of a mobile communication terminal of the present invention has many advantages. First, if the battery power for the communication module is used up, the power of the battery for the PDA module can be supplied to the communication module, thereby extending a use available time for the call service. In addition, if the remaining capacity of the battery supplying power to the PDA is below a predetermined level necessary to operate the PDA module, the power supply to the PDA module can be discontinued and the remaining power can be supplied only to the communication module, so that call service can be continuously provided to the user.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A power supply apparatus of a mobile communication terminal comprising:
a common battery for supplying power to a personal digital assistant (PDA) module and a communication module;
a switch connected between the common battery and the PDA module; and
a level sensing means for sensing a remaining capacity of the common battery and controlling the switch.

2. The apparatus of claim 1, wherein the switch is turned on if an initial power supplied is above a predetermined level and the switch remains on if the remaining capacity of the battery is above a predetermined level.

3. The apparatus of claim 1, wherein the level sensing means turns off the switch if the remaining capacity of the battery is below a predetermined level.

4. A power supply apparatus of a mobile communication terminal comprising:
a first battery for supplying power to a personal digital assistant (PDA) module;
a second battery for supplying power to a communication module;
a first switch connected between the first battery and the PDA module;
a second switch connected between the first battery and the communication module;
a first level sensing means for sensing the remaining capacity of the first battery and controlling the first switch; and
a second level sensing means for sensing the remaining capacity of the second battery and controlling the second switch.

5. The apparatus of claim 4, wherein the first and second switches are turned on and off, respectively, if an initial power supplied by the first and second batteries is above a first and a second level, respectively, and remains as such if the remaining capacity of the first and second batteries are above a first and a second level, respectively.

6. The apparatus of claim 4, wherein the first level sensing means turns off the first switch if the remaining capacity of the first battery is below a first level, and wherein the second level sensing means turns on the second switch if the remaining capacity of the second battery is below a second level.

7. The apparatus of claim 6, wherein the first level is greater than the second level.

8. A power supply apparatus of a mobile communication terminal comprising:
a first battery for supplying a power to a personal digital assistant (PDA) module;
a second battery for supplying a power to a communication module;
a first switch connected between the first battery and the PDA module;
a second switch connected between the first battery and the communication module;
first and second level sensing means for sensing remaining capacities of first and second batteries, respectively; and
a controller for controlling operations of the first and second switches and the PDA module depending on the remaining capacities of the first and second batteries.

9. The apparatus of claim 8, wherein the first and second switches are turned on and off, respectively, if an initial power supplied by the first and second batteries is above a first and a second level, respectively, and remains as such if the remaining capacity of the first and second batteries are above a first and a second level, respectively.

10. The apparatus of claim 8, wherein when the second switch is turned on, the controller controls the power supplied to the PDA module according to a use state of the PDA.

11. The apparatus of claim 8, wherein when the remaining capacity of the first battery is below a first level, the controller turns off the first switch, and wherein when the remaining capacity of the second battery is below a second level, the controller turns on the second switch.

12. The apparatus of claim 11, wherein the first level is greater than the second level.

13. The apparatus of claim 11, wherein the first and second levels are power levels at which the PDA module and the communication module are not stably operable.

14. A power supplying method of a mobile communication terminal comprising:
supplying power from a common battery to a personal digital assistant (PDA) module and a communication module;
sensing a remaining capacity of the common battery; and
discontinuing power from the common battery to the PDA module if the sensed remaining capacity is below a predetermined level.

15. The method of claim 14, wherein the predetermined level is a power level at which the communication module is not stably operable.

16. A power supply method of a mobile communication terminal comprising:
supplying power from a first battery to a personal digital assistant (PDA) module;
supplying power from a second battery to a communication module;
detecting remaining capacities of the first and second batteries; and
controlling the power from the first battery to the communication module and from the first battery to the PDA module.

17. The method of claim 16, wherein controlling the power from the first battery comprises:
checking whether the remaining capacity of the second battery is below a second level;
supplying power from the first battery to the communication module if the remaining capacity of the second battery is below the second level;
checking whether the remaining capacity of the first battery is below a first level; and
discontinuing power from the first battery to the PDA module if the remaining capacity of the first battery is below a first level.

18. The method of claim 17, wherein the first and second levels are power levels at which the communication module and the PDA module are not stably operable, and wherein the first level is greater than the second level.

19. The method of claim 16, wherein controlling the power from the first battery comprises:
checking whether the remaining capacity of the second battery is below a second level;
checking whether the remaining capacity of the first battery is above the first level if the remaining capacity of the second battery is below the second level;
supplying power from the first battery to the communication module if the remaining capacity of the first battery is above the first level; and
discontinuing power from the first battery to the PDA module if the remaining capacity of the first battery is below the first level.

20. The method of claim 19, further comprising:
checking whether the PDA module is in use when the power supply from the first battery to the communication module is initiated;
turning on both the PDA module and the communication module if the PDA is in use; and
turning on the communication module and turning off or leaving off the PDA module if the PDA module is not in use.

21. An apparatus, comprising:
a first module to perform a first prescribed function of the apparatus;
a second module to provide a second prescribed function of the apparatus; and
a first battery to provide power to the first and second modules, wherein power is provided by the first battery to one of the first and second modules when a remaining battery capacity of the first battery reaches a prescribed level.

22. The apparatus of claim 21, wherein the first module comprises a personal digital assistant (PDA) and wherein the second module comprises a communications module.

23. The apparatus of claim 21, further comprising a switch connected between the first battery and the first module, wherein the switch disconnects power from the first battery to the first module when the remaining capacity reaches the prescribed level.

24. The apparatus of claim 21, further comprising:
a second battery connected to the second module;
a first switch between the first battery and the first module;
a second switch between the first battery and the second module;
a first level sensing means for sensing the remaining capacity of the first battery and controlling the first switch; and
a second level sensing means for sensing a remaining capacity of the second battery and controlling the second switch.

25. The apparatus of claim 24, wherein when the remaining capacity of the first battery reaches the prescribed level, the second level sensing means controls the second switch to disconnect power from the second battery to the second module.

26. The apparatus of claim 21, further comprising:
a second battery connected to the second module;
a first switch between the first battery and the first module;
a second switch between the first battery and the second module;
a first level sensing means for sensing the remaining capacity of the first battery;
a second level sensing means for sensing a remaining capacity of the second battery; and
a controller for controlling operations of the first and second switches and one of the first and second modules depending on the remaining capacities of the first and second batteries.

27. The apparatus of claim 26, wherein when the remaining capacity of the first battery reaches the prescribed level, the controller controls the second switch to disconnect power from the second battery to the second module.
